(19) United States
(12) Patent Application Publication
(10) Pub. No.: US 2008/0035873 A1
(43) Pub. Date: Feb. 14, 2008

(54) Variable orifice gate valve

(76) Inventor: Rickey E. Wark, The Woodlands, TX (US)

Correspondence Address: YOUNG & BASILE, P.C., 3001 WEST BIG BEAVER ROAD, SUITE 624, TROY, MI, 48084, US

(21) Appl. No.: 11/502,712

(22) Filed: Aug. 11, 2006

(51) Int. Cl. F16K 3/00

(52) U.S. Cl. 251/212

(57) ABSTRACT

A gate valve for use in a supply conduit for airborne particulate coal being supplied to an input port of a multi-port combustion chamber. The gate valve comprises a circumferential support and a plurality of truncated sector-shaped valve elements which can move radially in and out relative to a common center between maximal blockage and minimal blockage positions. Air jets are provided for cleaning accumulated coal fines from the valve elements.

### FIELD OF THE INVENTION

This invention relates to gate valves for use in regulating the flow of airborne particulates such as pulverized coal. A specific application of the valve is in the balancing of multiple parallel streams of airborne pulverized coal to different locations in a combustion chamber for a boiler.

### BACKGROUND

Coal-fired electric utility plants use combustion chambers having multiple inlet ports for fuel in the form of airborne streams of pulverized coal. The coal comes from a pulverizing device commonly known as a “classifier” and coal flows from the classifier to the input ports through parallel flow conduits. It is desirable to balance the flow rates in the parallel conduits for maximum efficiency of the fire ball in the combustion chamber. The flow rates in parallel conduits can become unbalanced as a result of different lengths, the longer conduits presenting higher resistance to the flow of airborne particulate coal.

Flow rates are controlled using gate valves which are inserted into the flow conduits. An example of a gate valve is shown in U.S. Pat. No. 6,009,899 assigned to Power & Industrial Services Corporation of Morgan, Pa. That valve uses plates which slide toward and away from one another across the diameter of a circular conduit to decrease and increase the size of the flow orifice between the plates. Various other gate valves are known in the art.

### SUMMARY OF THE INVENTION

The present invention provides a gate valve for regulating the flow of airborne particulate matter. It is preferably, but not necessarily, implemented in the form of an insert for installation in one or more of the flow conduits associated with a multi-port combustion chamber for receiving airborne particulate coal. It is characterized by a simple but effective “iris” design comprising a circumferential support and a plurality of truncated, sector-shaped valve elements mounted on the support in circumferentially contiguous fashion for radial movement between a first position in which the elements maximally block the air stream, and a second position in which the elements minimally block the air stream.

In the typical application, the maximal blockage is on the order of 35% while the minimal blockage is on the order of 0%. However, these are simply exemplary numbers and a valve using the invention may be designed using other. percentages of maximal and minimal blockage. In the preferred form hereinafter illustrated and described in detail, the elements all move radially toward and away from a common center and are manually adjusted by way of handles which are secured to the elements outside of the circumferential boundaries of the insert. When the elements are fully advanced into the air stream, their side edges come into full engagement, thereby effectively and uniformly narrowing the diameter of the air stream. When the elements are withdrawn toward the minimal blockage condition, the side edges of the elements tend to separate. The flow turbulence which is caused by the gaps between the separated elements can be minimized by designing the side edges of the elements in a stepped fashion such that they overlap when the elements are between the fully inserted and fully withdrawn positions.

The invention does not have to be implemented as a removable insert, but can be built permanently into a flow conduit.

An option hereinafter described is the use of air jets located around the support ring so as to direct blasts of air radially inward along the elements thereby to clear the elements of accumulated pulverized coal. This promotes the smooth movement of the elements and reduces wear.

The elements as well as much of the associated components of the slide mechanisms are preferably made from abrasion resistant materials such as alloys of steel, tungsten carbide, aluminum oxide and other cermets.

### BRIEF DESCRIPTION OF THE DRAWING

FIG. 1 is a diagrammatic view of a multiple conduit particulate coal supply system to a combustion chamber having four entry ports and utilizing valves constructed in accordance with the present invention;

FIG. 2 is a plan view of an illustrative valve embodiment employing the invention, showing the valve elements in the fully extended or maximal blockage positions;

FIG. 3 is a plan view of the valve of FIG. 2 showing the elements partially withdrawn toward a minimal blockage position;

FIG. 4 is a plan view of FIGS. 2 and 3 showing the elements fully withdrawn to a minimal or zero blockage condition;

FIG. 5 is a sectional view of the valve of FIGS. 2-4;

FIG. 6 is a plan view of a valve similar to the valve of FIGS. 2-5 but using elements having modified or stepped side edges;

FIG. 7 is a sectional view of two adjacent valve elements from the valve of FIG. 6; and

FIG. 8 is a plan view of another valve substantially identical to the valve of FIGS. 2-5, but adding the optional feature of multiple air streams for periodic cleaning purposes.

### DETAILED DESCRIPTION OF THE ILLUSTRATIVE EMBODIMENT

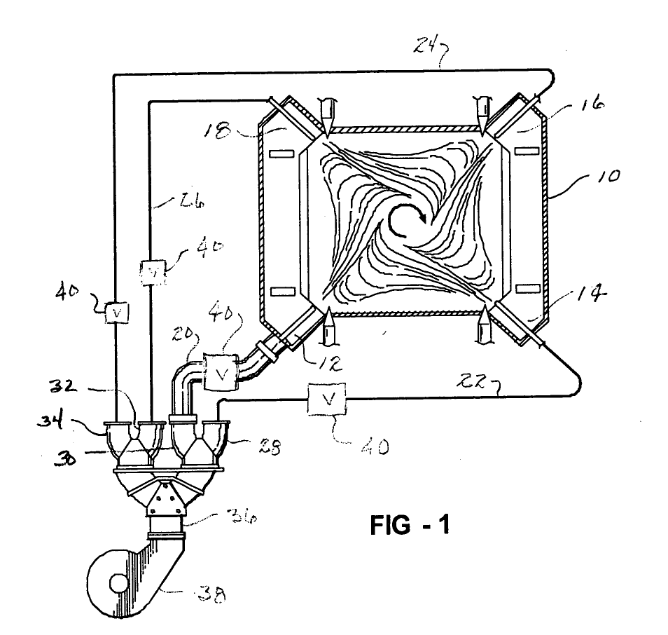

Referring now to FIG. 1, there is shown a combustion chamber 10 for a coal-fired utility plant having input ports 12, 14, 16 and 18 arranged at the four corners thereof. The input ports 12, 14, 16 and 18 are supplied by airborne particulate coal through conduits 20, 22, 24 and 26 respectively which are all of different effective lengths. The conduits 20, 22, 24 and 26 are connected to the manifold pipes 28, 30, 32 and 34 of a common source 36 of airborne particulate coal driven by a turbine-type blower 38. It will be understood by those skilled in the art that the components 28-38 are typically part of a classifier-type pulverizer which produces finely pulverized coal in a single airstream which is then divided up into four airstreams. The system of FIG. 1 further comprises identical valves 40 which are installed in each of the conduits 20, 22, 24 and 26. A common reference numeral is used for all of the valves 40 because they are all alike.

It will be understood that in any given system it may or may not be necessary or desirable to install four valves. It may be possible to achieve balance by installing valves 40 in only the two or three shortest conduits. In some cases only one valve will be required. It may or may not be necessary to keep all four valves, should all four valves be installed in the lines of a given system. It may, for example, be found necessary to install valves in only three conduits of a four conduit system after which the flow rates in the conduits are measured to determine the degree to which adjustment is necessary to balance the flow. It may be found that valves can be completely removed from one or more of the conduits, and used in other locations. The system of FIG. 1 is, therefore, exemplary in nature and may represent a transitory rather than permanent condition.

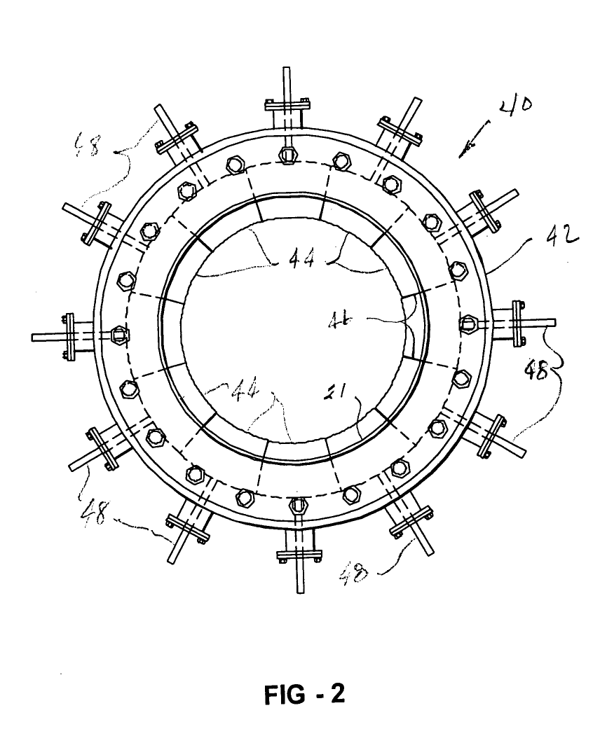

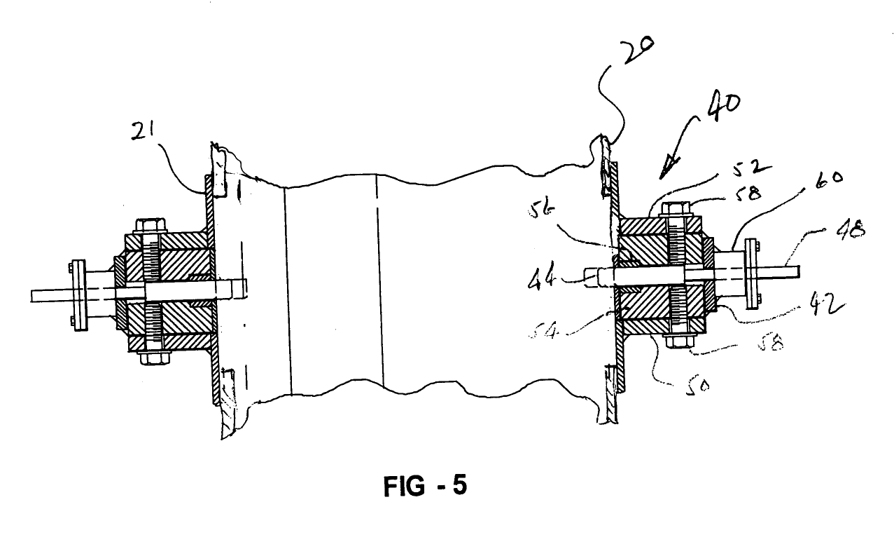

Referring now to FIGS. 2-5, the valves 40 will be described in detail. The valve 40 is preferably constructed as shown in FIG. 5 as a cylindrical insert 21 which can be inserted into and/or removed from a conduit such as 20 in the system of FIG. 1. Alternatively, it can be permanently integrated into the conduit.

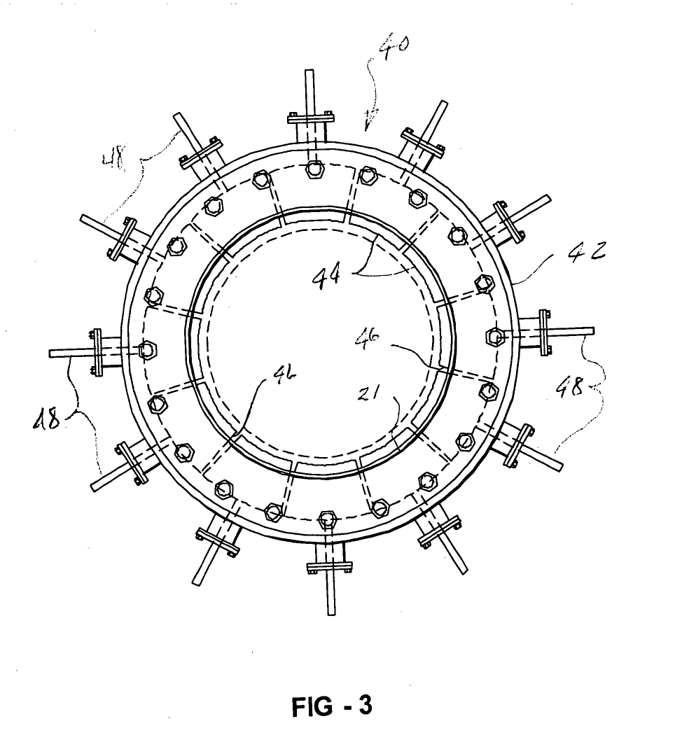

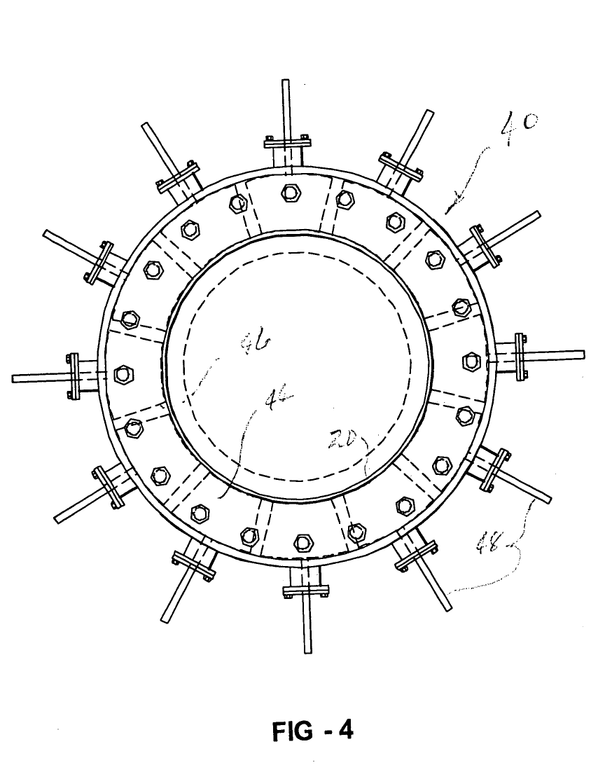

Continuing with the description of the valve 40, it comprises a circumferential support ring 42 and a number of truncated, sector-shaped valve elements 44 arranged in circumferentially contiguous fashion for radial movement between a first position shown in FIG. 2 in which the elements 44 maximally block the air stream by maximally reducing the effective cross-sectional area of the conduit in which the insert 21 is inserted, and a second position shown in FIG. 4 to which the elements 44 minimally block the air stream. In this case the degree of minimal blockage is zero. As shown in FIG. 3, the elements 44 can be placed in intermediate positions as desired.

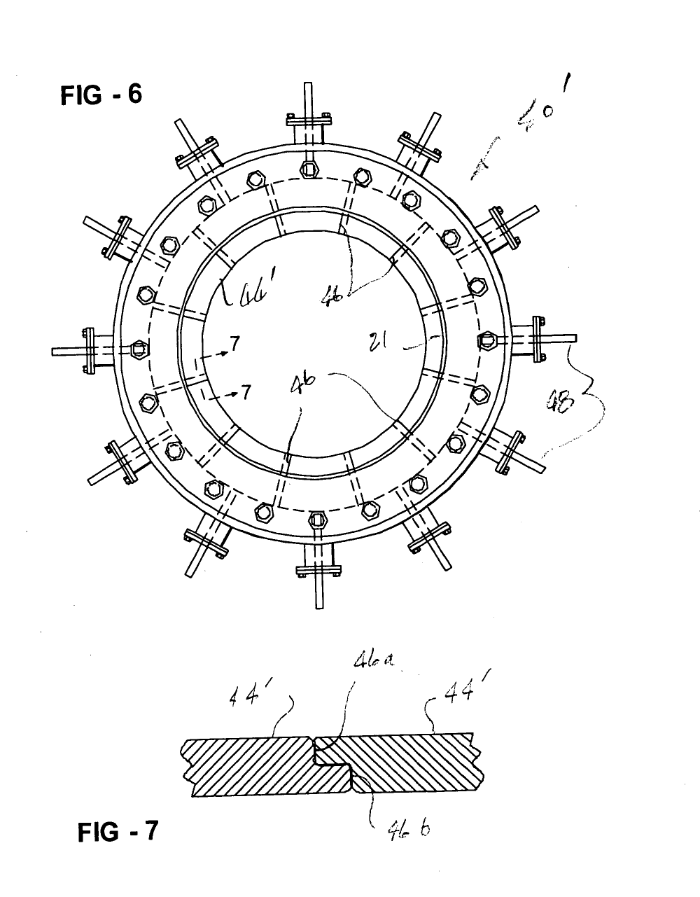

All of the valve elements 44 have side edges 46 which can either be straight as shown in FIGS. 3-5 or stepped as shown in FIG. 7. In either arrangement, the side edges 46 come into full engagement with one another when the elements 44 or 44′ are moved radially inwardly to the maximal blockage position. This provides a uniform reduction in the diameter of the flow path and minimized turbulence. Gaps between the side edges 46 appear as the elements 44 are moved radially outwardly toward a more minimal blockage condition. The stepped side edges 46a and 46b provide an overlap which maintains the uniformity of the cross-sectional area reduction in the intermediate positions of the modified elements 44′ thus to reduce turbulence which would otherwise be caused by flow through the gaps between the side edges 46 of the embodiment of FIG. 6. The two side edge designs are alternatives.

Handles 48 are preferably mechanically secured to the elements 44 and/or 44′ to assist in manually adjusting the radial positions of the elements 44 and 44′ as desired. Markings may be provided on the adjustment mechanisms to promote uniformity. In addition, a mechanized system may be contrived to cause simultaneous and uniform radial movement of all the elements 44 at the same time.

As shown in FIG. 5, rings 50 and 52 are welded to the outside of the insert cylinder 21 to support slide blocks 54 and wear plates 56 to act as guides and seals for the elements 44 in their radial sliding movement. The outside support ring 42 holds the structure together along with bolts 58. A block 60 is provided for the handle 48.

The separate insert arrangement of FIG. 5 allows the valve 40 to be demounted if it is found to be unnecessary and can be used in another system. In short, making the valve 40 as an insert with its own cylindrical housing is a way to facilitate installation and deinstallation. Where this feature is not needed, the valve 40 may be built integrally into the conduit 20 where it remains a permanent fixture.

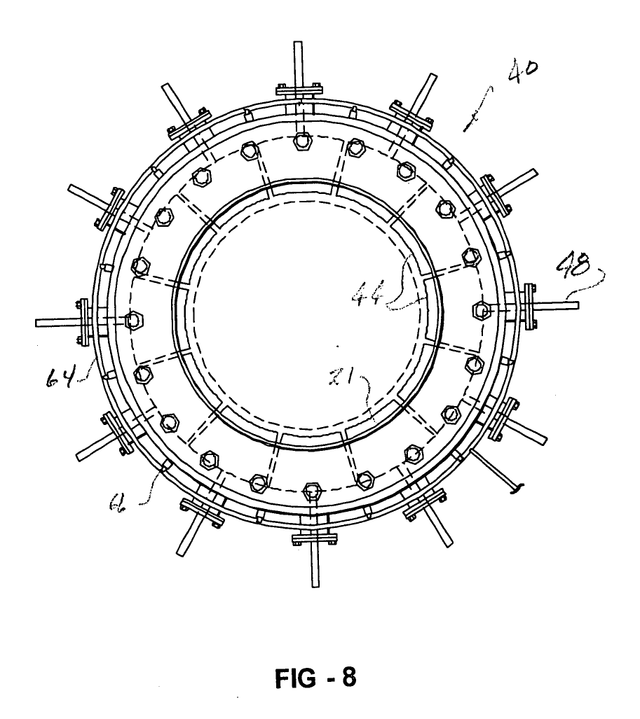

FIG. 8 shows an option in the valve 40 wherein a support ring 64 is added to support a plurality of air jets 66 which are supplied with air by a common source to aim blasts of air radially inwardly between the elements 44 and along the edge and top and bottom surfaces thereof to clear off accumulated coal fines which might otherwise clog and/or reduce the effectiveness of the valve action.

In practice the valves 40 are installed in as many lines of a system as are believed to be out of balance because of differences in length and/or effective flow resistances. The valves are adjusted as necessary to promote uniformity and balance in the flow rate, usually measured in pounds per hour, of particulate coal to the combustion chamber 10. If it is found that no adjustment is needed in any given line, the use of an insert makes it relatively easy to demount the valve and use it in another system.

What is claimed is:

1. A gate valve for regulating the flow of a stream of airborne particulate matter comprising:
a support; and
a plurality of truncated sector-shaped valve elements mounted on the support in circumferentially contiguous fashion for radial movement between a first position in which the elements maximally block the air stream and a second position in which the elements minimally block the air stream.

2. The gate valve as defined in claim I wherein the valve elements have side edges, the side edges of adjacent elements being in full engagement only when the elements are in the first position.

3. The gate valve defined in claim 2 wherein the side edges are step and wherein the stepped and wherein the stepped side edges of adjacent elements overlap when the elements are between the first and second position.

4. The gate valve defined in claim I further including handles attached to the elements for adjusting the positions of the elements between the first and second positions.

5. The valve defined in claim 2 further including a plurality of air jets disposed on the support to direct radial blasts of air between the side edges of the elements.

6. A gate valve insert for use in a conduit carrying an airborne stream of particulate coal to a combustion chamber comprising:
a support; and
a plurality of truncated sector-shaped valve elements mounted on the support in circumferentially contiguous fashion for radial movement between a first position in which the elements maximally block the air stream and a second position in which the elements minimally block the air stream.

7. The gate valve as defined in claim 6 wherein the valve elements have side edges, the side edges of adjacent elements being in full engagement only when the elements are in the first position.

8. The gate valve defined in claim 7 wherein the side edges are step and wherein the stepped and wherein the stepped side edges of adjacent elements overlap when the elements are between the first and second position.
